(19) United States
(12) Patent Application Publication
(10) Pub. No.: US 2015/0081517 A1
(43) Pub. Date: Mar. 19, 2015

(54) Derivatives Trading Platform Unique Package ID

(71) Applicant: trueEX Group LLC, New York, NY (US)

(72) Inventor: Sunil Hirani, Greenwich, CT (US)

(21) Appl. No.: 14/554,940

(22) Filed: Nov. 26, 2014

Related U.S. Application Data
(63) Continuation-in-part of application No. 13/864,988, filed on Apr. 17, 2013.
Application No. 13/864,988 is a continuation-in-part of application No. 13/446,998, filed on Apr. 13, 2012.
Application No. 13/446,998 is a continuation-in-part of application No. 13/938,879, filed on Jul. 10, 2013.
Application No. 13/938,879 is a continuation-in-part of application No. 13/947,696, filed on Jul. 22, 2013.
Application No. 13/947,696 is a continuation-in-part of application No. 14/217,314, filed on Mar. 17, 2014.
(60) Provisional application No. 61/909,085, filed on Nov. 26, 2013.
(60) Provisional application No. 61/687,088, filed on Apr. 17, 2012.
(60) Provisional application No. 61/517,110, filed on Apr. 13, 2011.
(60) Provisional application No. 61/627,868, filed on Oct. 18, 2011.
(60) Provisional application No. 61/686,113, filed on Mar. 29, 2012.
(60) Provisional application No. 61/669,887, filed on Jul. 10, 2012.
(60) Provisional application No. 61/728,960, filed on Nov. 21, 2012.
(60) Provisional application No. 61/825,432, filed on May 20, 2013.
(60) Provisional application No. 61/674,155, filed on Jul. 20, 2012.
(60) Provisional application No. 61/684,465, filed on Aug. 17, 2012.
(60) Provisional application No. 61/728,960, filed on Nov. 21, 2012.
(60) Provisional application No. 61/825,432, filed on May 20, 2013.
(60) Provisional application No. 61/793,128, filed on Mar. 15, 2013.

(51) Int. Cl. G06Q 40/04

(52) U.S. Cl. CPC G06Q 40/04
USPC 705/37

(57) ABSTRACT

A system and method for implementing a unique trade package identification number to be associated with a trade package and the constituent individual transactions associated with the trade package, such that the unique trade package identification number allows for more efficient correlation of trade packages and constituent individual transactions.

### PRIORITY INFORMATION

The present application is a utility application, and claims priority to U.S. Provisional Patent Application Ser. No. 61/909,085, filed Nov. 26, 2013, titled “PTC Unique Package ID,” the content of which is incorporated herein in its entirety by reference thereto. The present application is also a continuation-in-part of U.S. patent application Ser. No. 13/864,988, titled “System and Method for Managing Derivative Instruments”, filed on Apr. 17, 2013, the content of which is incorporated herein in its entirety by reference thereto, which claims priority to U.S. Provisional Patent Application Ser. No. 61/687,088, filed on Apr. 17, 2012, titled “Unwinds Concept”, the content of which is incorporated herein in its entirety by reference thereto. The present application is also a continuation-in-part of U.S. patent application Ser. No. 13/446,998, titled “System and Method for Interest Rate Swaps”, the content of which is incorporated herein in its entirety by reference thereto, which claims priority to U.S. Provisional Application Ser. No. 61/517,110, filed on Apr. 13, 2011, titled “Method and System for Interest Rate Swaps”, the content of which is incorporated herein in its entirety by reference thereto, U.S. Provisional Application Ser. No. 61/627,868, filed on Oct. 18, 2011, and titled “Method and System for Interest Rate Swaps”, the content of which is incorporated herein in its entirety by reference thereto, and U.S. Provisional Application Ser. No. 61/686,113, filed on Mar. 29, 2012, titled “Credit Limit Concept”, the content of which is incorporated herein in its entirety by reference thereto. The present application is also a continuation-in-part of U.S. patent application Ser. No. 13/938,879, filed on Jul. 10, 2013, and titled “System and Method for Managing Derivative Instruments”, the content of which is incorporated herein in its entirety by reference thereto, which claims priority to U.S. Provisional Patent Application Ser. No. 61/669,887, filed on Jul. 10, 2012, and titled “Margin Optimizer Concept”, U.S. Provisional Application Ser. No. 61/728,960, filed Nov. 21, 2012, and titled “Margin Optimizers”, and U.S. Provisional Application Ser. No. 61/825,432, filed May 20, 2013, and titled “FCM Capital Optimization Strategy (COSTM)”, the content of which is incorporated herein in its entirety by reference thereto. The present application is also a continuation-in-part of U.S. patent application Ser. No. 13/947,696, titled “System and Method for Managing Credit Default Swaps”, filed on Jul. 22, 2013, the content of which is incorporated herein in its entirety by reference thereto, which claims priority to U.S. Provisional patent application Ser. No. 61/674,155, filed on Jul. 20, 2012, and titled “Trading Platform for Futures Products”, U.S. Provisional Application Ser. No. 61/684,465, filed Aug. 17, 2012, and titled Trading Platform for Futures Products”, U.S. Provisional Application Ser. No. 61/728,960, filed Nov. 21, 2012, and titled “Margin Optimizers”, and U.S. Provisional Application Ser. No. 61/825,432, filed May 20, 2013, and titled “FCM Capital Optimization Strategy (COSTM)”, the content of which is incorporated herein in its entirety by reference thereto. The present application is also a continuation-in-part of U.S. patent application Ser. No. 14/217,314, titled “Trading Platform for Invoice Spread Products”, filed on Mar. 17, 2014, the content of which is incorporated herein in its entirety by reference thereto, which claims priority to U.S. Provisional Patent Application Ser. No. 61/793,128, filed on Mar. 15, 2013, the content of which is incorporated herein in its entirety by reference thereto.

### BACKGROUND

Trading of derivative based financial instruments is a significant economic activity for financial institutions. As such, the efficiency with which these transactions can be handled is of significant interest to entities involved in the derivative markets.

To improve the ability of these players to enter into and manage transactions involving derivative products, Applicant has developed a swap platform to improve the efficiency with which transactions can be entered into, and the ability of participants to manage portfolios of derivative instruments. Applicant's platform is discussed in greater detail in Applicant's copending U.S. patent applications Ser. No. 13/446,998, titled “Method and System for Interest Rate Swaps”, the content of which is incorporated herein in its entirety by reference thereto, Ser. No. 13/864,988, titled “System and Method for Managing Derivative Instruments”, Ser. No. 13/938,879, titled “System and Method for Managing Derivative Instruments”, Ser. No. 13/947,696, titled “System and Method for Managing Credit Default Swaps”, the content of which is incorporated herein in its entirety by reference thereto, and Ser. No. 14/217,314, titled “Trading Platform for Invoice Spread Products”, the contents of each of which are incorporated herein in their entireties by reference thereto.

Complicating the ability of entities to enter into and manage transactions involving derivative instruments are significant recent additions to financial reporting rules and regulations, often involving an intermediary entity, such as a central clearing party, to ensure transparency to the transaction. These rules and regulations require the careful tracking of transactions involving derivative instruments in order to remain in compliance with the rules and regulations.

Transactions involving derivative instruments are commonly identified by the assignment of a unique identification number to each trade package. Each trade package may include multiple transactions within the trade package. For example, where a specific position is traded, the size of the position being traded may result in the transaction being accomplished with multiple counter parties, with each counterparty transacting a portion of the trade. Present systems utilize a trade package identifier, such that identifying transactions within a trade requires first acquiring the trade record, then breaking down the record to determine individual transactions within the trade package. This limits the efficiency with which a party to such a transaction can manage the transaction, both from a historical as well as reporting standpoint.

### SUMMARY OF THE INVENTION

To improve the efficiency with which the components of a trade can be managed, Applicant has developed a management system involving a unique identifier for the trade as a whole, such that the trade itself has a unique identification number which allows both management of a portfolio through trade based actions, as well as transaction based actions. The unique package identifier may be encoded to allow information identifying parameters associated with the trade to be incorporated within the trade package identifier itself, thus increasing the ability of entities to quickly and efficiently manage portfolios of derivative positions.

In one aspect the present invention is directed towards a derivatives trading management platform incorporating a coded unique package identifier, the system including a coded unique package identifier implemented through a unique package identifier generator. The platform may further comprise a unique package identifier database for correlating transactions within a trade, allowing identification of transactions within a trade without requiring implementation of a search routine of all transactions to identify which transactions are associated with a particular unique package identifier. The unique package identifier may additionally be correlated with a Trade ID, where such a Trade ID is established by a participant to a transaction, a counterparty, or a clearing party involved in the transaction.

In an alternate form, the present invention may be embodied in a method for providing a unique trade package identification number, the method comprising the steps of receiving an indicator that a trade package has been finally approved, determining a trading platform identifier on which the trade package is being processed, determining a transaction type for the trade package which has been finally approved, determining a present date for said unique trade package identification number, determining a sequential trade number, analyzing the trade package to determine the number of individual transactions within the trade package, assigning sequential transaction numbers to the individual transactions, aggregating the individual values to form a unique trade package identification number, and reporting the unique trade package identification number to databases and services associated with the trade package.

In a further form, the present invention may be embodied in a system for providing a unique trade package identification number for derivative instrument trading platforms, the system having a unique trade package identification number generator for generating a unique trade package identification number, with the number including information to identify a trading platform, a transaction date, a transaction type, a number for identifying a trade package, and a number for identifying an individual transaction associated with the trade package, an internal clock for establishing the date on which the trade package was finalized, and an internal counter for establishing a sequential number for said trade package.

### BRIEF DESCRIPTION OF THE FIGURES

FIG. 1 is a schematic diagram that illustrates notional position values for a unique trade package identifier according to an embodiment of the present invention.

FIG. 2 illustrates a schematic diagram of a unique trade package identifier showing sample values for a particular transaction.

FIG. 3 illustrates a flow chart for implementing a unique trade package identifier in accordance with an embodiment of the present invention.

FIG. 4 illustrates a notional derivative instruments trading platform implementing unique trade package identifiers in accordance with an embodiment of the present invention.

### DETAILED DESCRIPTION OF THE INVENTION

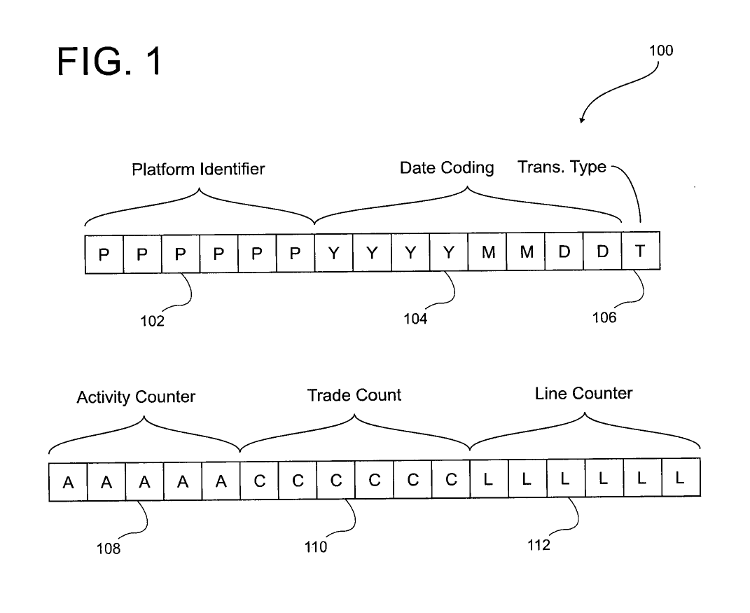

As shown in FIG. 1, the present invention may be implemented through a coded unique package identifier 100, which includes not only a unique identifier for the trade package itself, but also allows individual transactions within the trade package to be identified. The package identifier 100 may utilize a fixed length variable, with portions of the variable dedicated to different aspects of a trade, allowing both quicker search of trade packages, as well as rapid identification and access to individual transactions within a specific trade package.

A first portion 102 of the package identifier 100 may be utilized to identify a trading platform on which the trade occurred, such as Applicant's Portfolio Termination and Compaction platform. This portion may be encoded, such as through the use of the first six characters within the package identifier 100 being used to hold an acronym or other form of an identifier of the trading platform itself. The platform identifier 102 may be followed by a set of characters 104 to identify the date on which the trade occurred. As shown in FIG. 1, the format of the information may be four positions for the year in which the trade occurred, followed by two digits to identify the month in which the trade occurred, followed by two digits to identify the date on which the transaction occurred. Alternately, the date portion may be encoded using alternate forms, such as four digits to identify the year, followed by three digits to identify the day of the year on which the trade occurred (e.g., using 1-365 or 366 to identify the particular date.)

The date positions may be followed by a trade type identifier 106, to allow rapid identification of the trade package type. For example, the position may use either alpha or numeric characters, with particular characters being used to identify the trade type, such as where T equates to a termination package, C equates to a compaction package, R equates to a rebalance package, B equates to a backload package, O equates to an order book package, M equates to a margin optimization package, and F equates to a fly package. These examples are for illustration only, however the use of readily understandable characters may assist trade participants and others to readily identify a trade type without recourse to translation tables to identify the meaning of a particular character.

The following positions 108 may be used to identify a particular trade package for a given day, using a sequential counter to establish the identifier. For example, where five (5) positions are used to identify the trade package for the day, 00001 may be used to identify the first trade of the day, while 99999 may be used to identify the 99 thousandth, nine hundred and ninety ninth trade of the day. The counter may additionally be indexed to only count for a given trade type, such that separate counters could be maintained for each trade type.

The following fields may be utilized to identify the number of transactions within a package 110. For example, where three positions are compacted through a single counter party, the package would include three transactions, and a six position field would be identified as 000003. As is apparent in the industry, and from Applicant's prior disclosures, a single trade package may involve a large number of transactions being involved within the trade package, hence the provision of a large field for a transaction count within the identification. Finally, the remaining positions 112 can be used for sequential identifiers for the transaction packages, such that each transaction has a unique number within the package identifier, and can thus be individually identified and/or associated with a trade package.

Accordingly, while the first twenty six (26) positions of the unique identifier shown in FIG. 1 may be specific to the trade package, the remaining six (6) digits may be specific to individual transactions within the trade package, such that not only does the identifier serve as a unique identifier for the trade package, it may also be used to identify individual transactions.

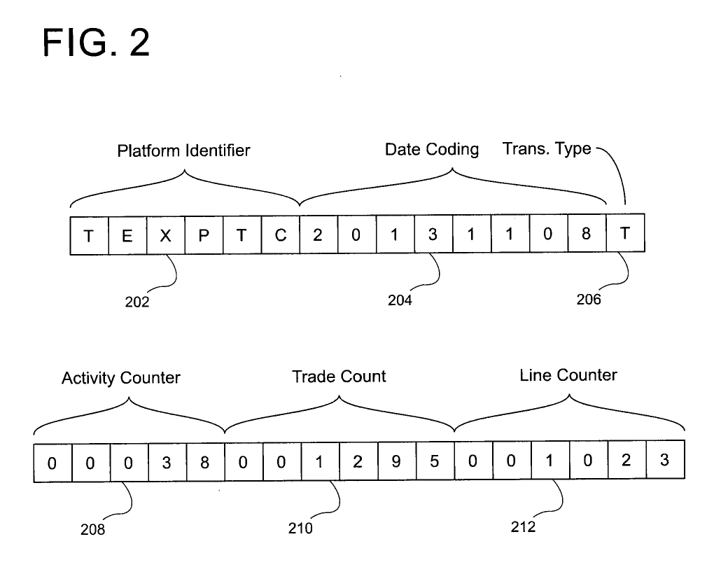

FIG. 2 illustrates an exemplary unique trade package identifier value for a particular transaction, in this case TEXPTC20131108T00038001295001023. In this example, TEXPTC 202 may be used to indicate that the platform on which the unique trade package identifier is being implemented is the trueEX Portfolio Termination and Compaction platform (TEXPTC), that the trade package was executed on Nov. 8, 2013 (“20131108”) 204, that the trade package involved a termination (“T”) 206, that the trade package was the 38^{th} trade package executed on that day (“00038”) 208, that the trade package included 1295 individual transactions within the overall trade package (“001295”) 210, and that the particular line number that the particular unique trade package identifier was assigned to was the 1023^{rd} transaction/line which was part of the particular trade package (“001023”) 212.

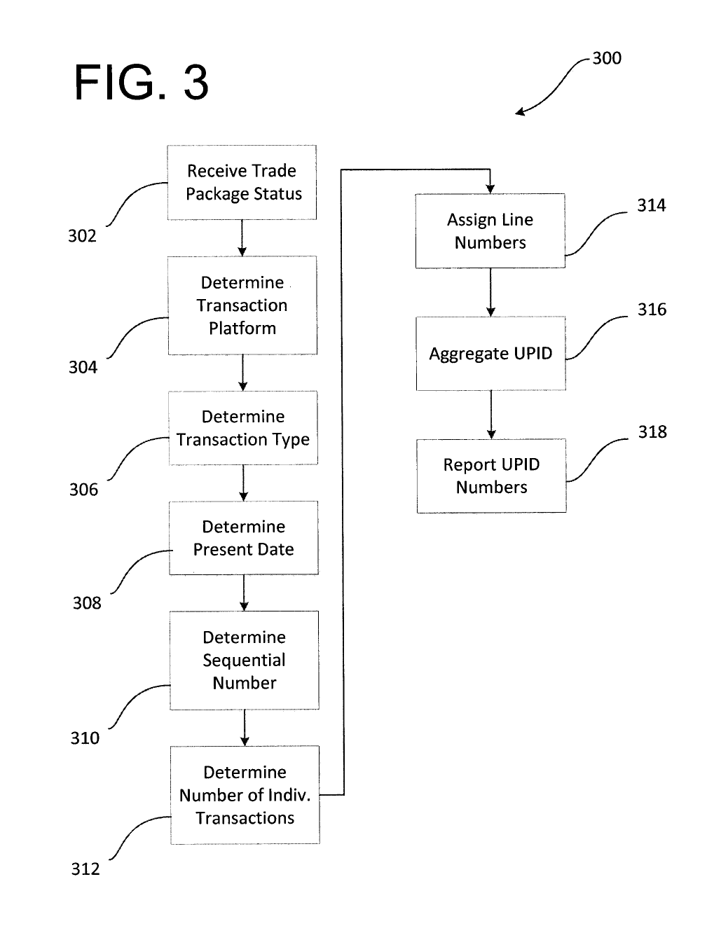

As can be seen in FIG. 3, the unique trade package identifier can be implemented through a process 300 overlayed with the processes such as those described in Applicant's earlier patent applications. The process may be initiated 302 by a signal that a trade package has reached a final approval state. The final approval state may be identified by acceptance by both parties to a transaction in the case of a simple transaction, or by acceptance of the trade package by the last party to indicate acceptance of the trade package in the case of a transaction involving multiple parties. Alternately, the trade package may be indicated as in a final approval state when the package is ready for forwarding to a central clearing party.

Once the indication has been received that a trade package has been finalized, the generator may identify 304 on which platform/service the trade package was executed on. Individual exchanges in the market may utilize one or more platforms, dependent on the transaction type being implemented. Alternately, a single exchange may use a common platform, with different modules associated with the platform, such that different platform modules may each be assigned a unique platform identifier.

Once the indication that the trade package is in a final approval status, the platform on which a participant is implementing or managing the transaction may determine 306 a transaction type. As discussed above, multiple transaction types can be implemented. The transaction type can be determined internally via the functionality being implemented by the participant, such that it is automatically determined.

The platform may then determine 308 the present date from an internal clock, to determine the date code portion of the unique package identifier. The platform may also query an internal counter to determine 310 the sequential number of the transaction, e.g., to determine how many trade packages have already been implemented by the platform for the day, such that the next sequential number can be implemented with the unique package identifier for the instant trade package.

The trade package itself may then be analyzed by the generator to determine 312 the number of individual transactions which comprise the full trade package. Each transaction within the trade package may then be assigned a line number, with a different line number for each transaction. The order to count each transaction/line item in a package in general does not matter, except for with respect to compaction packages. For compaction packages, the individual transactions associated with terminated line items should be assigned 314 transaction numbers before the new trades in the package.

Once the unique package identifier has been aggregated 316, it can then be reported 318 internally in the platform to associate the unique package identifier with the instant trade package, as well as with the individual transactions which comprise the trade package itself. Furthermore, the unique package identifier may be communicated, if desired, to third parties to utilize the unique package identifier with other services received by the participant, such as reports generated by a central clearing party, to allow the participant to readily associate activities at the third party with a particular trade package.

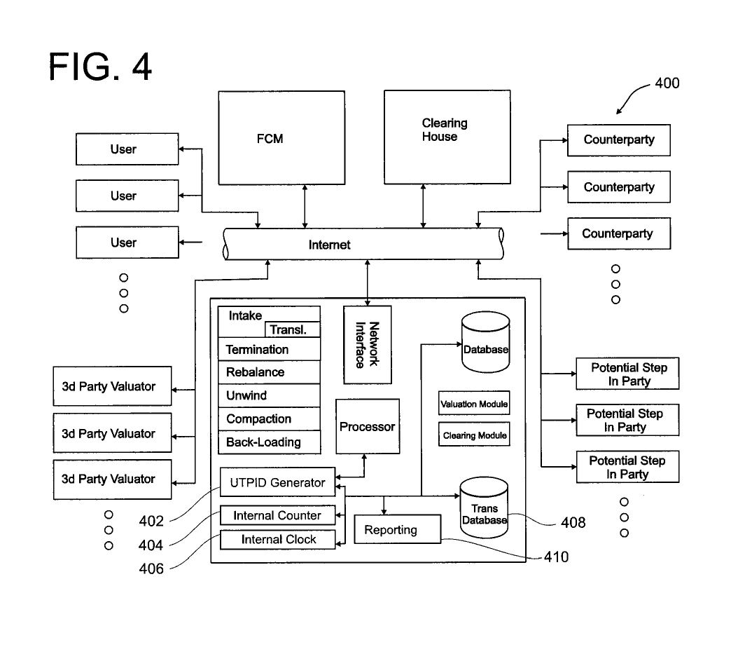

As shown in FIG. 4, the unique trade package identifier can be implemented in derivative financial instrument trading platforms 400, such as the platform described in Applicant's previously filed U.S. patent application Ser. No. 13/864,988 and titled “System and Method for Managing Derivative Instruments”. As shown in FIG. 4, the present invention may be implemented such as in the system described in the above application by the inclusion of functional capabilities to implement the unique trade package identification determination and reporting. The platform of the system may be provided with a unique trade package identification generator 402 which generates the unique identification number in accordance with the above by reference to an internal counter 404 which generates the next sequential trade number for a given day, and an internal clock 406 which identifies the current date. The internal counter will preferably reset each day, such that the counter starts at 1 for each day, while the internal clock can provide the date in any format suitable for use as part of the unique trade package identification number.

The unique trade package identification generator may also include a module for associating and reporting 408 the unique trade package identification number with trading records, such that the unique trade package identification number can be properly associated with records allowing subsequent searching of records. Additionally, the platform may be provided with a database 410 for storing transaction records and associated unique trade package identification numbers, such that future correlations may be obtained from stored records, rather than through a search of all transaction records for the unique trade package identification number.

The present invention may be embodied in other specific forms without departing from the spirit or essential attributes of the invention. Accordingly, reference should be made to the appended claims, rather than the foregoing specification, as indicating the scope of the invention.

What is claimed is:

1. A method for providing a unique trade package identification number, the method comprising the steps of:
Receiving an indicator that a trade package has been finally approved;
Determining a trading platform identifier on which said trade package is being processed;
Determining a transaction type for said trade package which has been finally approved;
Determining a present date for said unique trade package identification number;
Determining a sequential trade number;
Analyzing said trade package that has already been approved to determine a number of individual transactions associated with said trade package;
Assigning line numbers to each individual transaction associated with said trade package;
Aggregating said trading platform identifier, transaction type, present date, sequential number, and number of individual transactions associated with said trade package to form a portion of said unique trade package identification number to establish a trade package identification; and
Assigning a line number to each individual transaction associated with said trade package;
Aggregating said portion of said unique trade package identification number to said line numbers to establish unique trade package identification numbers;
Reporting said unique trade package identification numbers to a database for correlation with said individual transactions and said trade package.

2. A method for providing a unique trade package identification number in accordance with claim 1, wherein said step of determining a present date further comprises generating a date code in a year/date/month format.

3. A method for providing a unique trade package identification number in accordance with claim 1, wherein said step of determining a present date further comprises generating a date code in a year/sequential date format.

4. A method for providing a unique trade package identification number in accordance with claim 1, wherein the step of determining a sequential trade number comprises determine a sequential number for a trade based on all trades having occurred prior to a trade on a date on which said trade package was finalized.

5. A method for providing a unique trade package identification number in accordance with claim 1, wherein the step of determining a sequential trade number comprises determine a sequential number for a trade based on all trades for a given transaction type having occurred prior to a trade on a date on which said trade package was finalized.

6. A method for providing a unique trade package identification number in accordance with claim 1, wherein said step of reporting said unique trade package identification numbers further comprises reporting said unique trade package identification number to a third party.

7. A method for providing a unique trade package identification number in accordance with claim 6, wherein said third party is a central clearing party.

8. A method for providing a unique trade package identification number in accordance with claim 1, wherein when said trade package is a compaction package, said line numbers are assigned to individual transactions in which positions are terminated before line numbers are assigned to individual transactions which create new positions.

9. A method for providing a unique trade package identification number in accordance with claim 1, wherein a portion of said unique trade package identification number is utilized to identify a specific trade package, with said portion of said unique trade package identification number being reported to a database for correlation with said individual transactions and said trade package.

10. A system for generating a unique trade package identification number implemented in a derivatives trading platform, the system comprising:
A unique trade package identification number generator for generating a unique trade package identification number, said number comprising information to establish a trading platform, a transaction date, a transaction type, a number for identifying a trade package, and a number for identifying an individual transaction associated with said trade package;
An internal clock for establishing a transaction date; and
A sequential counter for establishing a sequential number for said trade package.

11. A system for generating a unique trade package identification number in accordance with claim 10, further comprising a reporting module, said reporting module reporting a generated unique trade package identification number to a database for associating said unique trade package identification number with individual transactions associated with a trade package.

12. A system for generating a unique trade package identification number in accordance with claim 11, wherein said reporting module reports said unique trade package identification number to a third party,

13. A system for generating a unique trade package identification number in accordance with claim 12, wherein said third party is a central clearing party.

14. A system for generating a unique trade package identification number in accordance with claim 10, wherein said sequential counter identifies a sequential number for a trade based on all trades having occurred prior to a trade on a date on which said trade package was finalized.

15. A system for generating a unique trade package identification number in accordance with claim 10, wherein said sequential counter identifies a sequential number for a trade based on all trades for a given transaction type having occurred prior to a trade on a date on which said trade package was finalized.

16. A system for generating a unique trade package identification number in accordance with claim 10, wherein said transaction date utilizes a year/day/month format.

17. A system for generating a unique trade package identification number in accordance with claim 10, wherein said transaction date utilizes a year/sequential date format.
